(19) United States
(12) Patent Application Publication
(10) Pub. No.: US 2002/0054036 A1
(43) Pub. Date: May 9, 2002

(54) Display device

(75) Inventors: Mark Thomas Johnson, Eindhoven (NL); Neil Christopher Bird, Horley Surrey (NL)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 09/992,927

(22) Filed: Nov. 5, 2001

(30) Foreign Application Priority Data
Nov. 8, 2000 (EP) 00203924.6

(51) Int. Cl. G09G 5/00

(52) U.S. Cl. 345/204

(57) ABSTRACT

A low power standby driving mode is obtained by using extra columns (14) (or rows) by which only a small area of the display is driven. For standby driving, a separate driver (11) is used at the edge of the panel, or this driver is combined with the normal driver. In another embodiment, the standby driving mode is obtained by splitting columns (6) (or rows (5)) so that only a defined area (12) of the display is driven during standby driving. For normal driving, an additional row (16) and switches (17) may be used to interconnect separate parts of a split electrode via switches.

The invention relates to a display device comprising, on a substrate, a matrix of selection electrodes and data electrodes with a pixel at the area of a crossing of the selection electrodes and data electrodes, and at least one switching element and drive means for driving the selection electrodes and data electrodes.

Examples of such active matrix display devices are the TFT-LCDs or AM-LCDs which are used in laptop computers and in “organizers”, but they also find an increasingly wider application in GSM telephones. Instead of LCDs, (polymer) LEDs, electrochromic or other display devices may be used.

A problem in many portable display devices is the power consumption. This problem also occurs if the display device is a reflective display device (in which the power consumption for a backlight is avoided).

In such portable applications, the required drive voltages for the liquid crystal display device are supplied by one or more drive ICs which usually determine a major part of the energy consumption of the display device.

It is an object of the present invention to provide a display device of the type described in the opening paragraph with a lower energy consumption so that it can be used for a longer period on a single battery charge.

A first embodiment of the display device according to the invention is characterized in that the display device comprises means for reducing the capacitance for a part of the group of selection electrodes or the group of data electrodes with respect to that of further selection electrodes or data electrodes.

A second embodiment of the display device according to the invention is characterized in that the display device comprises means for temporarily reducing the capacitance for at least a part of the group of selection electrodes or the group of data electrodes.

The invention is based on the recognition that a major part of the energy consumption in the drive ICs is the result of charging and discharging stray capacitances of the column electrodes, for example, at the area of cross-overs and (be it to a lesser degree) of charging and discharging stray capacitances of the row electrodes. By reducing these stray capacitances for a part of these electrodes, for example, the electrodes used in the standby mode, a considerable reduction of the power consumption, notably in said standby mode can be realized.

Said capacitance reduction may be permanent, for example, in that a part of the group of data electrodes has a smaller length than further data electrodes, or temporary, for example, because data electrodes comprise a plurality of sub-electrodes which can be interconnected by means of switching elements.

These and other aspects of the invention are apparent from and will be elucidated with reference to the embodiments described hereinafter.

In the drawings:

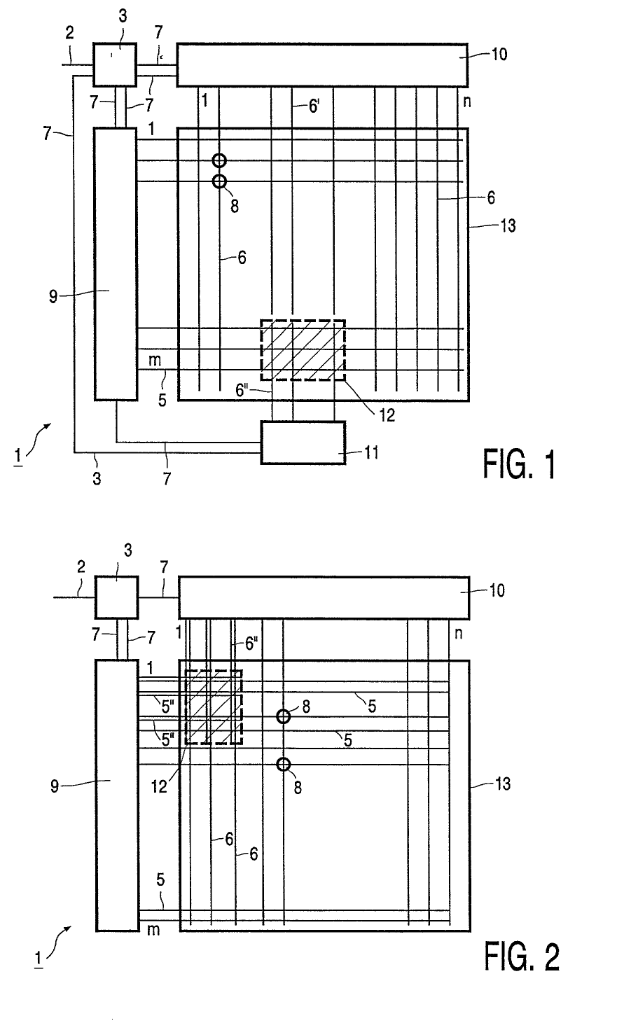

FIG. 1 shows diagrammatically an embodiment of a display device according to the invention,

FIGS. 2 to 5 show variants of FIG. 1, while

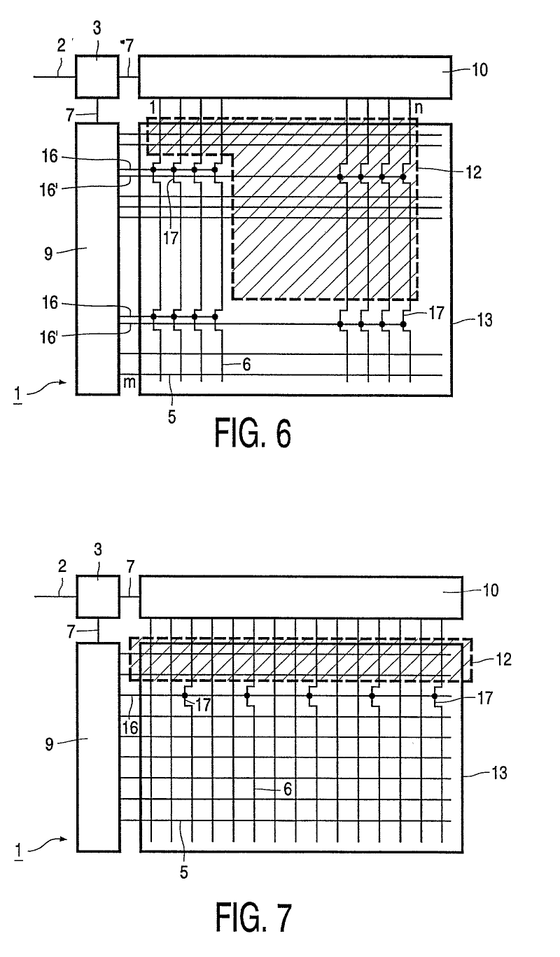

FIG. 6 shows another embodiment of a display device according to the invention, and

FIG. 7 shows a variant of FIG. 6.

The Figures are diagrammatic and not drawn to scale. Corresponding elements are generally denoted by the same reference numerals.

FIG. 1 shows an electrical equivalent of a display device 1 to which the invention is applicable. It comprises a display panel 13 with a matrix of pixels 8 at the area of crossings of m row or selection electrodes 5 and n column or data electrodes 6. The row electrodes are successively selected via a row driver 9 while the column electrodes are provided with data via either a data register or a column driver 10. If necessary, incoming data signals 2 are first processed in a processor 3. Mutual synchronization takes place via drive lines 7.

In the present example, the pixels 8 form part of a liquid crystal display device. In the conventional active matrix TFT technology, TFT transistors (not shown in FIG. 1) associated with a pixel are activated via a selection pulse at the gate electrode, while the voltages at the data electrodes connected to the source electrodes of the TFT transistors determine the voltage at the picture electrodes connected to the drain electrodes.

During use of such a display device, capacitances associated with the pixels (pixel capacitances) are charged in conformity with the information to be displayed. To this end, new information is usually presented to the column electrodes during every selection period so that the stray capacitances associated with these column electrodes are continuously charged or discharged. Said stray capacitances are constituted, for example, by a crossing of a column electrode and a row electrode with the interpositioned insulating layer as a dielectric. A large part of the energy is then used, often more than for charging the pixel capacitances. This energy is dissipated both in the actual display panel 13 and in the drivers 9, 10. Notably in portable apparatus, particularly in telecommunication applications, this energy is also used in the standby mode in which only a small part of the display panel is actually used.

In the example of FIG. 1, information is displayed in said standby mode in the part 12 of the display panel. Dissipation of energy in the other part of the display panel 13 (and the associated drive electronics in the register 10) is prevented by giving the column electrodes 6″ in the part 12 a smaller length than the column electrodes 6 in the actual display part. In this example, the column electrodes 6″ are driven by means of a separate column driver 11 and are in alignment with column electrodes 6′, so that the display panel is actually split up into two parts. The column electrodes in the standby part 12 are usually short so that narrower electrodes may be used for this purpose without any loss of velocity, with the result that the above-mentioned stray capacitances are small in this part and the power loss thus decreases to a further extent. The other part of the panel is not activated in the standby mode, for example, by applying no voltages or small voltages.

When the complete display panel is used, the part 12 and the other part of the display panel are activated. By using a separate standby mode, as in this example, it can be optimized for a low power consumption, while the column driver 10 is optimized for a maximum display performance. Mutual synchronization and adjustment of the standby mode is effected again via drive lines 7 and the drive circuit 3.

The functions of the column driver 11 may, however, also be taken up in the column driver 10. This is shown in FIG. 2 in which, in addition to a number of selection electrodes 5, sub-electrodes 5″ are realized for the standby part 12, and similarly, next to column electrodes 6, sub-electrodes 6″ are realized for the standby part 12.

In the standby mode, the row driver 9 selects the shorter (narrower) sub-electrodes 5″ and in the display mode it selects the electrodes 5, and simultaneously, information (standby or current information) is presented to the electrodes 6″ and 6, respectively. The drive is such that either sub-pixels for the standby mode or information display is selected. Separate switches or a combination of p and n MOS transistors may be used for this purpose.

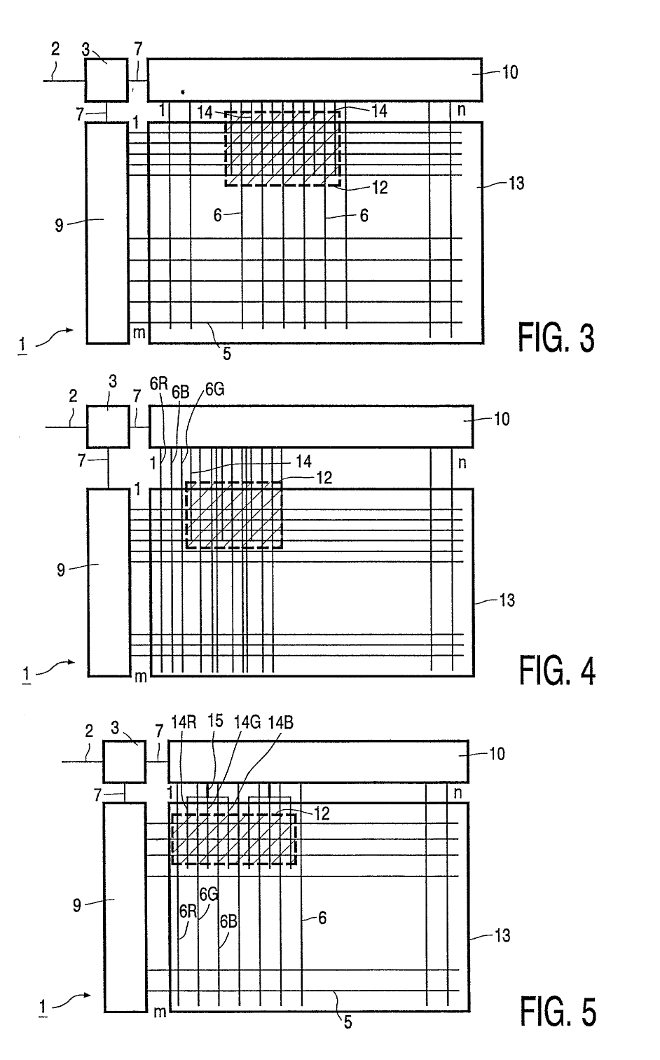

FIG. 3 shows a variant in which, for the standby mode, shorter electrodes 14 between the column electrodes 6 are realized for the standby part 12. The shorter electrodes 14 have a lower stray capacitance than the actual column electrodes so that the dissipation can be very small again in the standby mode. This is notably achieved when the drive section for the actual selection and column electrodes can be switched off during standby. Other reference numerals have the same significance as in the previous examples.

The extra, shorter electrodes increase the number of outputs of the column driver 11, notably in color display devices. Moreover, there are now extra electrode tracks in the standby part 12. This is at the expense of the resolution in the display mode. In the display device of FIG. 4, this is compensated by providing only shorter column electrode tracks in addition to column electrodes of one color, green in this example, but a combination of red and green is also possible. The message in the standby mode is then of course displayed in green only. Another solution is shown in the display device of FIG. 5 in which the short column electrode tracks 14R, 14G, 14B are mutually short-circuited and are driven via a common connection 15 to the column driver 10. The message in the standby mode is now displayed in black, white and, if necessary, grey. In both examples, the number of extra outputs for the standby mode has decreased by ⅔.

A completely different solution is shown in FIG. 6. The column electrodes 6 are now split up into sub-column electrodes which can be mutually interconnected by means of switches, in this example TFT transistors, which are selected by means of extra row electrodes 16, 16′. By bringing the transistors to the on-state via the extra row electrodes 16, 16′, different parts of the column electrodes are interconnected. When one or more groups are switched off, the column electrodes that are driven temporarily have a lower stray capacitance so that also in this case the energy consumption in the standby mode is reduced. In the example of FIG. 6, the standby part 12 is L-shaped, but, dependent on the number of extra row electrodes 16, 16′ and switches, other shapes may be alternatively chosen.

Similarly as in the example of FIG. 4, the number of switches (TFT transistors) may be reduced for the sake of a larger aperture by splitting them up into the columns of only one color which is again green in this example. Such an embodiment is shown in FIG. 7.

The protective scope of the invention is not limited to the embodiments shown. As stated in the opening paragraph, the pixels may be alternatively formed by (polymer) LEDs, while the invention is also applicable to other display devices based on, for example, electro-optical or electromechanical effects.

The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

1. A display device (1) comprising, on a substrate, a matrix of selection electrodes (5) and data electrodes (6) with a pixel (8) at the area of a crossing of the selection electrodes and data electrodes, and at least one switching element and drive means (3, 9, 10, 11) for driving the selection electrodes and data electrodes, characterized in that the display device comprises means for reducing the capacitance for a part of the group of selection electrodes (5) or the group of data electrodes (6) with respect to that of further selection electrodes (5) or data electrodes (6).

2. A display device as claimed in claim 1, characterized in that a part of the group of data electrodes (6″) has a smaller length or width than further data electrodes.

3. A display device as claimed in claim 2, characterized in that the display device comprises, in alignment with the data electrodes (6″) having a smaller length or width, data electrodes (6′) having a smaller length or width than the further data electrodes.

4. A display device as claimed in claim 1, characterized in that a part of the group of selection electrodes has a smaller length or width than further selection electrodes.

5. A color display device as claimed in claim 1, characterized in that the display device comprises data electrodes of a smaller length only for pixels of one color.

6. A display device as claimed in claim 1, characterized in that the drive means at least temporarily supply drive voltages to the group of electrodes having a reduced capacitance.

7. A color display device as claimed in claim 1, characterized in that the drive means have at least one common connection for a plurality of data electrodes of a smaller length.

8. A display device (1) comprising, on a substrate, a matrix of selection electrodes (5) and data electrodes (6) with a pixel at the area of a crossing of the selection electrodes and data electrodes, and at least one switching element and drive means for driving the selection electrodes and data electrodes, characterized in that the display device comprises means (16, 17) for temporarily reducing the capacitance for at least a part of the group of selection electrodes (5) or the group of data electrodes (6).

9. A display device as claimed in claim 8, characterized in that data electrodes comprise a plurality of sub-electrodes which can be interconnected by means of a switching element (17).
